(19) United States
(12) Patent Application Publication
(10) Pub. No.: US 2008/0256840 A1
(43) Pub. Date: Oct. 23, 2008

(54) Sound producing fishing float

(76) Inventor: John Phillip Rodriguez, Slidell, LA (US)

Correspondence Address: J. Phillip Rodriguez, 129 Woodruff DR., Slidell, LA, 70461, US

(21) Appl. No.: 11/789,174

(22) Filed: Apr. 23, 2007

(51) Int. Cl. A01K 93/00

(52) U.S. Cl. 43/42.31; 43/44.91; 43/44.9

(57) ABSTRACT

A sound producing fishing float constructed to allow a fishing line to freely slide back and forth through the float. A float stop secured on the fishing line above the float. A bead or beads secured on the fishing line below the float. When the fishing line is twitched by the fisherman, the line and beads slide up and contact the bottom of the fishing float in such a way as to create a chamber inside the sound structure threaded bore producing a fish attracting sound.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of Invention

This invention pertains to fishing accessories more particularly a fishing float which creates a sound chamber producing a fish attracting sound and is adjustable to different depths.

2. Description of Prior Art

Fishing floats and bobbers of prior art, with sound producing features have been developed for the fulfillment of countless objectives and requirements. With varying degrees of success

By way of example U.S. Pat. No. D314417 discloses sound produced by beads inside the float. U.S. Pat. No. 6,173,524 discloses sound produced by beads inside the float. U.S. Pat. No. 6,880,288 discloses sound produced by beads inside the float. U.S. Pat. No. 6,138,398 discloses sound produced by electronic means. U.S. Pat. No. 6,098,331 discloses sound produced by electronic means. U.S. Pat. No. 4,638,585 discloses sound produced by electronic means.

A disadvantage of electronic sound producing floats of the prior art. After the float is cast into the water it must be reeled in to change the sound pattern and some floats are constant with no adjustment. A disadvantage of floats with mechanical devices or free moving objects inside of the float, they can be manipulated by wind and waves into producing sound.

while these devices fulfill their respective objectives and requirements the aforementioned patents do not describe a fishing float that creates a sound chamber and produces a sound, fully controllable by the fisherman while the float is in the water.

### BRIEF SUMMARY OF THE INVENTION

In view of the foregoing the object of the present invention, provide an improved sound producing fishing float.

Another object of the present invention a sound chamber being created by the fisherman twitching on the fishing line. Putting the fisherman in complete control to when and how frequent to make the fish attracting sound.

Yet another object of the present invention allowing the fishing line to freely pass through the locking mechanism channel allows the float to slide up and down the fishing line making it adjustable at various depths, and still being capable of creating the sound chamber at various depths, giving control to the fisherman.

A further object of the present invention the quick and easy attachment and removal to and from the fishing line without cutting the line or untying a knot.

Still yet another object of the present invention the channel of the locking mechanism being offset of the center, Allows the float stop to be of the smallest possible size, Aiding during reeling the fishing line in and casting the float out. The float stop passes through the rod guides without hanging or snagging on the rod guides.

There has thus been outlined, rather broadly, the more important features of the invention in order that the detailed description that follows may be better understood, and in order that the art may be better appreciated.

In this respect, before explaining an embodiment of the invention in detail, it is to be understood that the invention is not limited in its application to the details of construction or the arrangement of the components set forth in the following description or illustrated in the drawings. Also it is to be understood that the phraseology and terminology employed herein are for the purpose of description and should not be regarded as limiting. It is important, therefore, that the claims be regarded as including equivalent construction insofar as they do not depart from the spirit and scope of the present invention.

### BRIEF DESCRIPTION OF THE SEVERAL VIEWS OF THE DRAWING

FIG. 1 Plan view of the present invention.

FIG. 2 A perspective view of the float.

FIG. 3 Plan view as seen from the top.

FIG. 4 A section view as view along line 4,4 of FIG. 1.

FIG. 5 A sectional view of the bottom portion of the float showing a bead contacting the sound structure threaded bore creating the sound chamber.

FIG. 6 An exploded view of the float components.

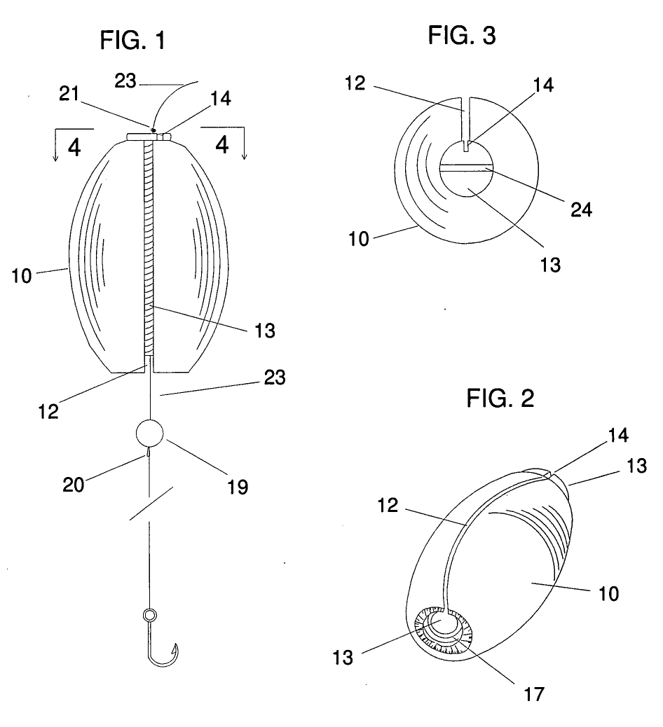

### DESCRIPTION OF THE PREFERRED EMBODIMENT

With reference to the drawings. The main body is of a buoyant material shaped as an oval 10 as illustrated in FIG. 6 however other shapes can be utilized. A bore 11 through the center of the float along the main axis from the top end to the top of the molded indention 22. The bore 11 serves as a guide for the locking mechanism 13 to line up with the sound structure threaded bore 17 and aides the locking mechanism channel 14 in securing the float 10 to the fishing line 23. A slit 12 from the exterior through to the bore 11 parallel with the bore 11 from the top end to the bottom end. A molded indention 22 on the bottom to secure the sound structure 15.

The threaded locking mechanism member 13 consists of a light weight material and can be either completely threaded or partially threaded on the bottom end. A channel 14 which is offset of the axis from the top to the bottom of the threaded locking mechanism member 13 and is parallel to and can be rotated to line up with the float slit 12 and the sound structure slit 16. The channel when in align with the float slit 12 and the sound structure slit 16 allows the float 10 to be installed on the fishing line 23 without the need to cut the fishing line 23 or untie the lure. The fishing line 23 passes from the exterior of the float 10 through the float slit 12 and the sound structure slit 16 into the locking mechanism channel 14 once the fishing line 23 is in the channel 14 rotation of the locking mechanism 13 unaligns the channel 14 from the float slit 12 and the sound structure slit 16 securing the float 10 on the fishing line 23. Realigning said parts releases the float 10 from the fishing line 23. The locking mechanism channel 14 allows the fishing line 23 to freely slide through the channel 14 which allows the float 10 to slide to slide up and down the fishing line 23. The locking mechanism key 24 is a groove on the top of the locking mechanism 13 to aid in turning the locking mechanism 13. The locking mechanism 13 slides through the float bore 11 to connect with the sound structure threaded bore 17.

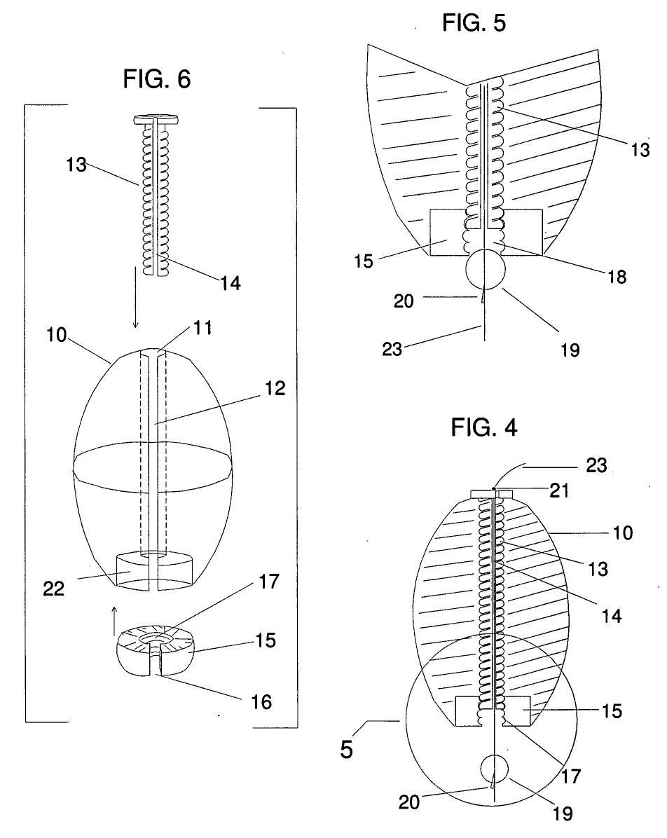

The sound structure 15 has a circular exterior shape as illustrated in FIG. 6 however other exterior shapes can be utilized. An consists of a malleable metal or other similar material a threaded bore 17 completely through the center inline with the float bore 11 an a slit 16 from the top to the bottom of the sound structure 15 from the exterior through to the threaded bore 17 which is parallel with the float slit 12. The locking mechanism 13 screws partially into the threaded bore 17 this leaves a space inside the threaded bore 17 between the bottom of the locking mechanism 13 and the bottom of the threaded bore 17 as shown in FIG. 4. When the fishing line 23 is pulled by the fisherman a bead 19 or beads 19 secured by a bead stop 20 on the fishing line 23 below the float 10, slides up with the fishing line 23 and contacts the bottom of the threaded bore 17. This action creates a chamber 18 within the threaded bore 17 between the top of the bead 19 and the bottom of the locking mechanism 13 as shown in FIG. 5. Producing a fish attracting sound

The bead or beads 19 are secured on the fishing line 23 below the float 10 with a wood or plastic peg as a bead stop 20 thus making the bead or beads 19 easily adjustable and lockable at various depths this along with the float stop 21 allows the sound chamber to be created and utilized at various depths. Different size beads 19 and beads 19 of different material compositions can be utilized to achieve different sounds.

The float stop 21 prevents the float 10 from sliding up the fishing line 23 past the predetermined depth and is made from a separate piece of monofilament line and is tied on the fishing line 23 above the float 10 and can slide up and down to a desired depth.

What I claim as my invention is:

1. A fishing float comprising a main body of a buoyant material, a main axial bore from the top end through the axis to the top of the molded seat, a radially extending slit from the top end to the bottom end in an aligned relation to said bore, the bottom portion molded in a shape to secure the sound structure, a threaded locking mechanism coincident with the float bore, an axial channel offset of the axis from the top to the bottom of the locking mechanism an aligned with the float slit, a sound structure in the molded seat on the bottom end, a threaded bore through its axis aligned with the main axial bore, a radially extending slit from the top to the bottom of the sound structure, in an aligned relation to the threaded bore and the float slit, said threaded locking mechanism screws partially into said sound structure threaded bore, leaving a void inside the threaded bore between the bottom of the threaded bore and the bottom of the locking mechanism, manipulation of the fishing line by the fisherman causes a bead or beads secured to the fishing line below the float, to slide up with the fishing line and contact the bottom of the threaded bore, creating a chamber inside the threaded bore between the top of the bead and bottom of the locking mechanism, which produces a sound.

2. A fishing float according to claim 1 further comprising said offset channel which allows the fishing line to slide freely through The channel.

3. A fishing float according to claim 2 further comprising said channel which allows the float to freely slide up and down the fishing line.

4. A fishing float according to claim 3 further comprising said channel being offset, enables a small perimeter channel which in turn allows a small float stop.

5. A fishing float according to claim 1 further comprising said threaded locking mechanism which can be rotated to align the locking mechanism channel with the float slit allowing for introduction of the fishing line to and from the channel, once the fishing line is in the locking mechanism channel, rotation of the locking mechanism unaligns the channel from the float slit, securing the float on the fishing line, when realigned the float slips off the line.

6. A sound producing fishing bobber: a main body with a density less than water; a main hole through the center from the top end to the top of the molded space on the bottom end; a cut from the top end to the bottom end parallel with the hole, from the exterior through to the hole; a threaded or partially threaded on the bottom end, male member, with an offset channel from the top end to the bottom end; a structure shaped to fit into the molded space, with a slit from the exterior through to the center parallel with the float slit, a threaded hole through its center in align with the float hole, thus allowing the male threaded member to line up with and penetrate partially into the threaded hole; a float stop secured above the float, a bead stop and bead secured below the float, limit the float travel up and down the fishing line, the combination thereof, designed, so as to allow a bead or beads to contact the bottom of the float, creating a chamber inside the threaded hole and producing a noise when the fishing line is manipulated by the fisherman.
